(19) United States
(12) Patent Application Publication
(10) Pub. No.: US 2010/0207483 A1
(43) Pub. Date: Aug. 19, 2010

(54) BRUSH ARRANGEMENT AND ELECTRIC MACHINE, IN PARTICULAR ELECTRIC DOMESTIC APPLIANCE

(75) Inventors: Maria Büttner, Schonau (DE); Andreas Kirchner, Gotha (DE); Herbert Pecat, Saal / Waltershausen (DE); Thomas Tripp, Bastheim (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/680,905

(22) PCT Filed: Sep. 12, 2008
(86) PCT No.: PCT/EP08/62189

§ 371 Date: Mar. 31, 2010

(30) Foreign Application Priority Data
Oct. 5, 2007 (DE) 10 2007 047 648.7

(51) Int. Cl. H01R 39/40

(52) U.S. Cl. 310/242

(57) ABSTRACT

A brush arrangement on an electric machine, wherein the brush arrangement includes a carbon brush; a brush sleeve having a use position and a safety position, wherein the brush sleeve holds the carbon brush and is fixable on the housing of the electric machine in the use position of the brush sleeve; and a catcher to lock the brush sleeve in the safety position when the brush sleeve leaves the use position.

### BACKGROUND TO THE INVENTION

The invention relates to a brush arrangement on an electric machine, in particular on an electric domestic appliance, having a brush sleeve which holds the carbon brush and can be fixed to the housing of the machine in a use position, and to an electric machine equipped therewith.

### PRIOR ART

A brush arrangement of the type cited in the introduction is known from the unexamined German patent application DE 197 17 594 A1.

The relevant machine has a pot-type housing made of an electrically conductive material, in which the commutator is rotatably mounted. Retaining means are molded to the region of the front face of the housing, said retaining means being used to hold the brush sleeves holding the carbon brushes. The carbon brushes are displaceably mounted in the brush sleeves and prestressed in the direction of the commutator by means of a helical compression spring. As the brush sleeves are similarly embodied to be electrically conductive, these must be rigidly fastened to a load-bearing portion made of an electrically insulating material, in particular plastic. Each load-bearing portion is inserted into the retaining means during assembly from the outside inwards in the direction of the commutator until the brush sleeves assume their use position. Here the contact spring of the stator connects to the radial surface of the relevant brush sleeve. In this position, locking and stop means secure the load-bearing portion and thus also the associated brush sleeve in all directions. A subsequent exchange of the load-bearing portion and the brush sleeve is essentially possible by means of a mechanical release of the locking connection and a displacement directed radially outwards. In rare exceptional cases, an unwanted release of the locking connection may also take place, particularly if, in the case of a fault, the temperatures in the electric machine increase to unusually high levels and the material of the load-bearing portion loses its rigidity.

### THE OBJECT UNDERLYING THE INVENTION

The object underlying the invention is to improve the reliability of an electric machine of this type even in the event of a fault.

### INVENTIVE SOLUTION

This object is achieved by a generic brush arrangement such that the brush arrangement has catch means, by means of which the brush sleeve can be locked in a safety position when it leaves the use position.

The invention can advantageously prevent the brush sleeve from moving out beyond the safety position if it is released in the event of a fault. In this way, the invention can ensure that the prescribed electrical safety distances, particularly in respect of the brushes and the brush sleeves, are maintained even in the event of a fault.

### PREFERRED EMBODIMENT OF THE INVENTION

Advantageous embodiments and developments, which can be used individually or in combination with one another, form the subject matter of the dependent claims.

According to a preferred embodiment of the invention, the catch means include at least one locking facility, which catches the brush sleeve in the safety position by means of locking Such a locking facility can realize the inventive catch means in a particularly simple and cost-effective fashion. The catch means particularly preferably secures the brush sleeve against a further displacement directed away from the commutator, in particular in the direction of other electrically conductive components of the machine. As a result, it is possible to maintain the safety distances between the brush arrangement and other conductive components surrounding the brush arrangement even in the event of a fault. This embodiment of the invention may be particularly advantageous if the brush sleeve is equipped with a compression spring or another means suited thereto in order to prestress the brush, said means, in the event of the brush sleeve releasing, promoting a displacement of the same from the commutator.

The locking facility advantageously comprises at least one recess provided on the radial surface of the brush sleeve, into which recess a lug resting against the radial surface in a use position engages when the safety position is reached and counteracts a further displacement by means of a form-fit. This embodiment allows the invention to be manufactured particularly easily in respect of the brush sleeve and essentially with a neutral effect on cost and weight.

The recess can be embodied here for instance to be circular or rectangular, in particular square. Such contours may be created without problems by means of boring and/or in particular stamping of the recess and within the scope of already necessary manufacturing steps as well as using tools and apparatuses which are already used in the manufacturing process.

The invention can be used particularly advantageously in a brush arrangement, in which the brush sleeve is embodied so as to be electrically conductive and thus to a particular degree to protect against unwanted contact with other electrically conductive components.

The lug, which is suited to engaging in the recess when the safety position is reached, is preferably formed by the contact spring of the stator, which has a rigidity which is adequate for securing the brush sleeve. Furthermore, the embodiment of the catch means in this case does not require any additional or modified components compared with the cited prior art with the exception of the adjusted brush sleeve and is therefore likewise essentially neutral in terms of cost and weight. When exchanging the brush sleeves, a retro-fitting of existing electrical devices with inventive catch means is essentially also possible, for instance within the scope of the already necessary replacement of a worn part.

The recesses in the radial surface of the brush sleeves are in their use position preferably arranged in a radial direction between the commutator and stator of the electrical machine and are displaced, in the case of an unwanted release, in the direction of the contact springs. This embodiment counteracts the most frequent faulty displacement of the brush sleeve in the event of a machine fault.

The contact springs of the stator advantageously rest in the use position of the brush sleeve in the direction of the commutator inclined against the contact surface of the brush sleeve. In the case of covering with the assigned recess, the relevant contact springs engages in the recess and is deformed with a further force acting on the brush sleeve radially away from the use position in the direction of a locking contour. As a result, the fault-specific and unwanted displacement of the brush sleeve in the direction of an electrical contact with other electrically conductive components is particularly reliably avoided. A renewed insertion of the brush sleeve to eliminate the fault is however also possible without any noticeably greater exerting of force.

The invention can also be used particularly advantageously with a brush arrangement, in which the housing of the relevant machine is also embodied in an electrically conductive fashion. In the case of electrical devices of this type a contact between the brush sleeve and the housing is to be reliably avoided. In an embodiment of this type, the brush sleeve is preferably fastened to an electrically insulating load-bearing portion, which can be used for its part in the retaining means provided on the housing and can in particular be inserted therein.

In the course of the assembly, the load-bearing portion can in this way be inserted into the retaining means of the housing preferably in the direction of the commutator, in other words in the direction of a generally conventional assembly direction of the brush sleeve. In this case, no doctrine which deviates from conventional practice need be communicated to the person skilled in the art who deals with the exchange of the brush sleeve.

According to another preferred embodiment of the invention, the catch means of the brush arrangement comprise a projection protruding from the brush sleeve, which strikes a safety element, in particular the contact spring, in the safety position. A projection of this type can be created for instance with minimal manufacturing effort by means of a local plastic deformation of the sleeve wall and likewise has essentially both a neutral effect on weight and cost.

Suitable means for defining the brush sleeve in the use position on the housing of the machine are known from the unexamined German patent application DE 19717594 A1, the overall content of which in this respect forms part of the present disclosure.

### BRIEF DESCRIPTION OF THE DRAWINGS

The invention is described in more detail below with reference to schematic drawings of two exemplary embodiments, in which;

FIG. 1 shows a top view onto the housing of an electric machine with an inventively embodied brush arrangement;

FIG. 2 shows a section I-I through the housing shown in FIG. 1 with brush sleeves disposed in the use position;

FIG. 3 shows the section I-I with brush sleeves disposed in the safety position;

FIG. 4 shows a perspective view of the module comprising brush sleeve, carbon brush and load-bearing portion;

FIG. 5 shows a perspective view of this module after insertion into the housing in the use position;

FIG. 6 shows the previously cited, perspectively represented module in the safety position,

FIG. 7 shows a brush arrangement according to another embodiment of the invention.

### DETAILED DESCRIPTION WITH THE AID OF AN EXEMPLARY EMBODIMENT

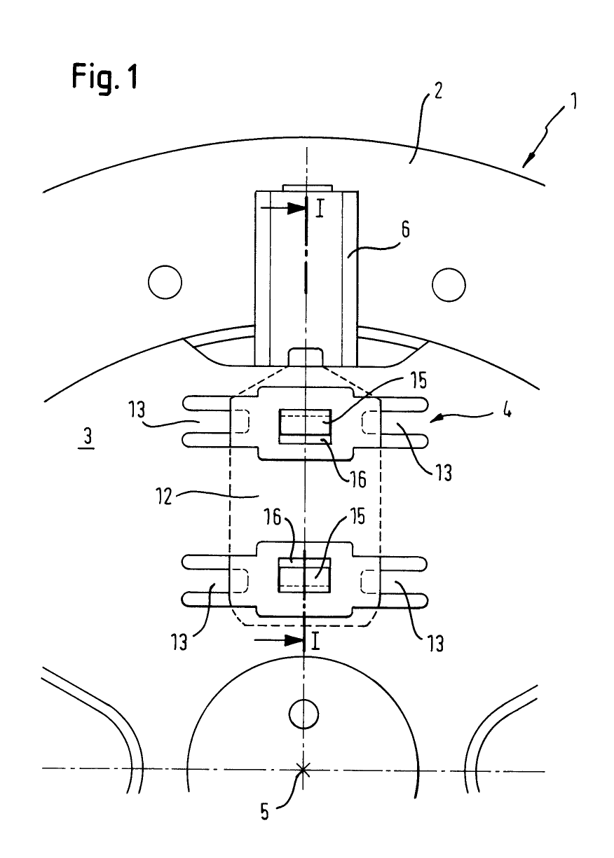

The electric machine 1 shown in FIG. 1 has a pot-type housing 2, which holds two identical brush arrangements 4 on its front face 3. The brush arrangements 4 are arranged in a mirror-symmetrical fashion facing one another in respect of a plane which intersects the axis of rotation 5 of the rotor. For simplification purposes, the Figures only show one brush arrangement 4 and which has a counterpart on the opposite side of the housing 2 (not shown).

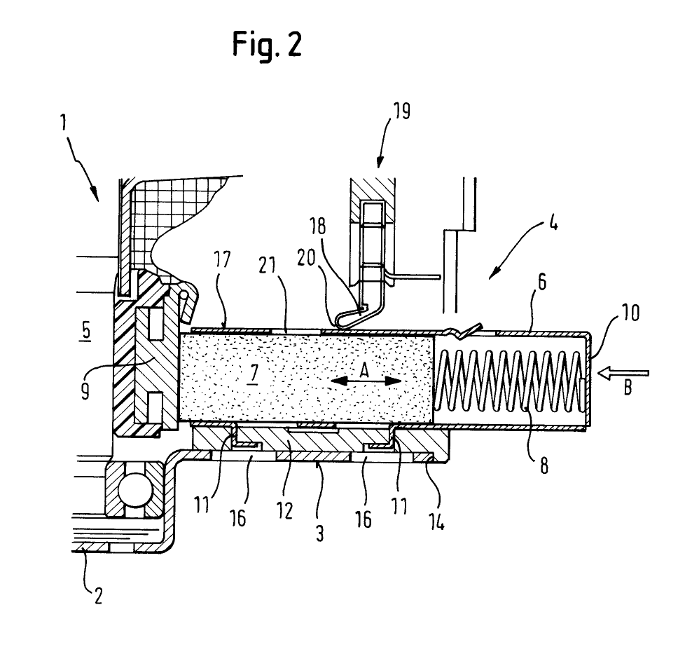

The structural design of the brush arrangement 4 is visible in detail in FIG. 2.

The brush arrangement 4 consists of a brush sleeve 6, in which a carbon brush 7 is displaceably arranged in the direction of arrow A. The carbon brush 7 is prestressed by a helical compression spring 8 in the direction of the commutator 9 connected to the rotor 5, with the end of the compression spring 8 facing the carbon brush 7 resting against the rear wall 10 of the brush sleeve 6. In the event of abrasion of the carbon brush 7 caused by friction on the commutator 9, this is displaced by the compression spring 8 in the direction of the commutator 9, as a result of which the abrasion is compensated until a wear limit has been reached.

The brush sleeve 6 and the housing 2 are each manufactured from a sheet-type, electrically conductive material, for instance made of sheet brass or steel. These materials have a high rigidity, and can be easily processed by means of extrusion, stamping or boring to form complex molded parts.

By way of an angular protruding leg 11 the brush sleeve 6 is connected in an unreleasable and form-fit fashion to a plate-type load-bearing portion 12, which consists of an electrically non-conductive material and electrically insulates the brush sleeve 6 from the housing 2. During assembly the load-bearing portion 12 for its part, together with the brush sleeve 6, is inserted in the direction of arrow B into tab-like retaining means molded on the housing 2, until a stop 14 protruding from the load-bearing portion 12 strikes the housing 2. A top view of the retaining means is also shown in FIG. 1.

In the use position now assumed (representation in FIG. 2), lugs 15 molded on the load-bearing portion 12 engage in recesses 16 in the front face 3 and secure the module comprising brush sleeve 6 and load-bearing part 12, during normal operation, against an unwanted displacement counter to the direction of arrow B. In respect of a possible constructive embodiment of a suitable facility for fixing this module, reference is again made to the publication DE 197 17 594 A1, in particular the description of the exemplary embodiment shown there in the drawings.

The contact spring 18 of the stator 19 rests elastically against the radial surface 17 facing away from the load-bearing portion 12. The contact spring 18 has a contact surface 20 which is inclined toward the radial surface 17 in the direction of the commutator 9, and rests against the radial surface 17 under prestress. The contact spring 18 is a component which is already to be provided on the electrical machine, and which can essentially be embodied unchanged in respect of its shape relative to suitable previously known solutions. In this case, an electric device which is not equipped in accordance with the invention during initial assembly can also subsequently be provided with catch means which correspond to the present invention, within the scope of a maintenance process for instance.

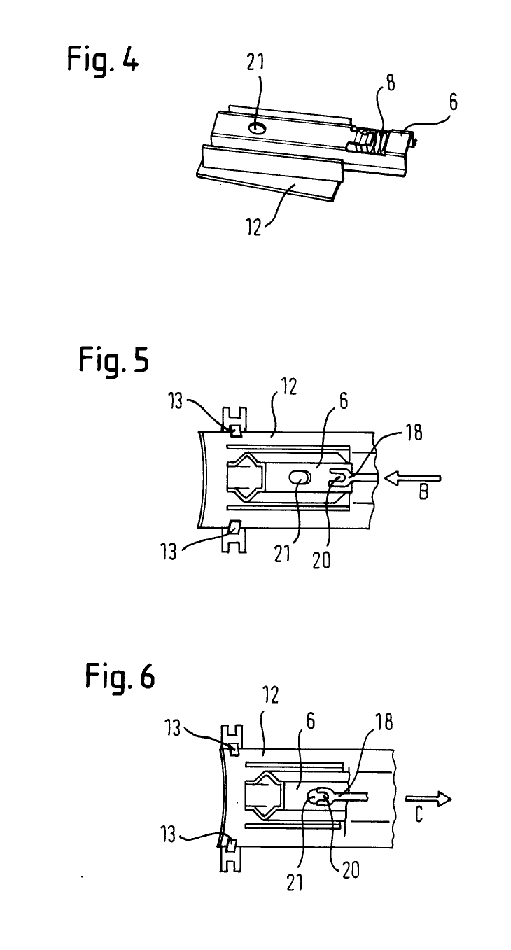

A circular recess 21 in the exemplary embodiment is also provided in the brush sleeve 6 between its end facing the commutator 9 and the contact spring 18, said recess having no function during fault-free operation of the electric machine 1 (as is also apparent from FIG. 5). The recess 21 may also comprise a contour which deviates from the circularity, which is for instance influenced by a preferred manufacturing method for the brush sleeve 6 or the design of the contact spring 18.

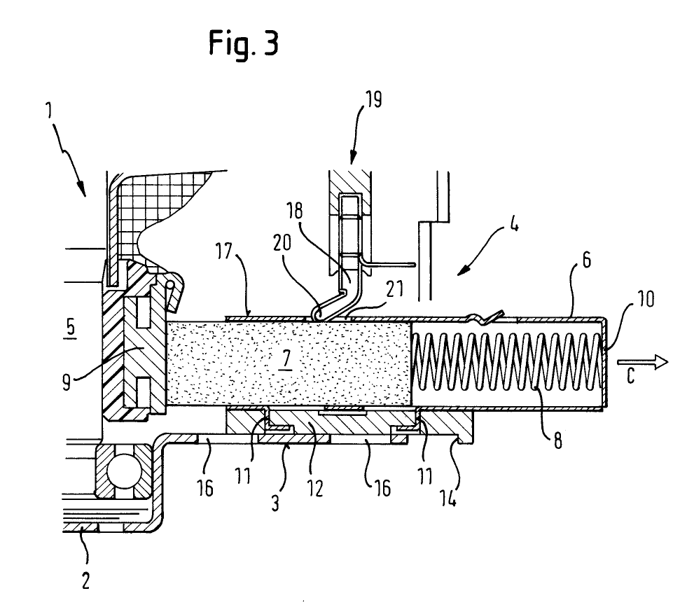

With a fault shown in FIGS. 3 and 6 however, in some circumstances, a displacement of the module shown separately in FIG. 1 comprising the brush sleeve 6 and the load-bearing portion 12 in the direction of arrow C, in other words counter to the assembly direction, can take place unintentionally, which is promoted by the prestressing of the compression spring 8. With a very extensive displacement of the brush sleeve 6, there is the risk of this electrically contacting the other electrically conductive components of the electric machine. Before an unwanted electrical connection of this type takes place, however, the contact surface 20 of the contact spring 18 covers the recess 21 and engages in a locking fashion into the recess 21 because the contact spring 18 is prestressed. In this safety position, a further displacement of the module from the brush sleeve and load-bearing portion 12 in the direction of arrow C and thus an electrical short-circuit are prevented. The fault is however essentially repairable by a renewed insertion of the component module comprising brush sleeve and load-bearing portion in the direction of arrow B, in other words towards the commutator 9.

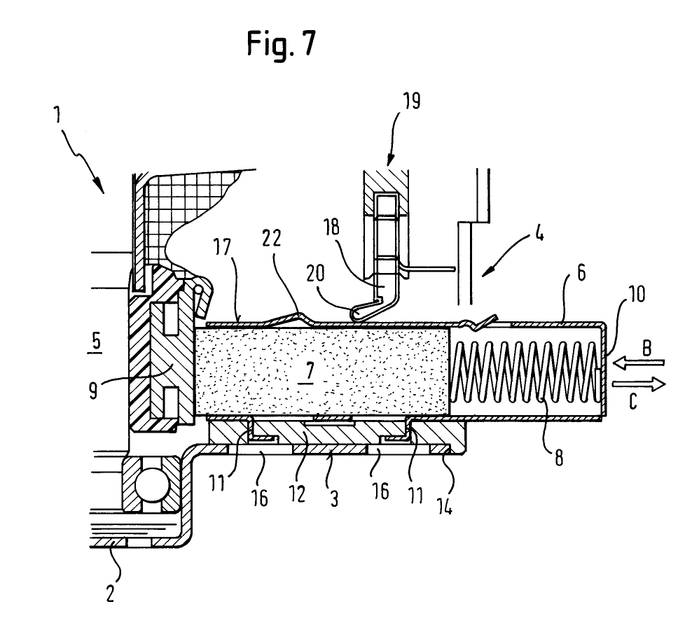

In the exemplary embodiment according to FIG. 7, the catch means for securing the brush sleeve 6 in its safety position consist of a projection 22 which protrudes from the radial surface 17 of the brush sleeve 6 away from the carbon brush 7, said projection only insignificantly negatively affecting the assembly (arrow B) of the module comprising brush sleeve 6 and load-bearing portion 12 as a result of its ramp-like embodiment, the displacement of which in the direction of arrow C nevertheless counteracting a considerable resistance after reaching the safety position. In this case, all components known from the prior art can essentially also be used unchanged with the exception of the brush sleeve 6, with the brush sleeve 6 itself essentially being manufacturable without additional costs or an increase in weight within the scope of the conventional manufacture with the features required to execute the invention. In the exemplary embodiment according to FIG. 7, a retrofitting of existing electric machines with inventive catch means is likewise also possible.

The features disclosed in the preceding description, claims and drawings may be significant both individually and also in any combination for the realization of the invention in terms of its different embodiments.

1-13. (canceled)

14. A brush arrangement on an electric machine having a housing, the brush arrangement comprising:
a carbon brush;
a brush sleeve having a use position and a safety position, the brush sleeve holding the carbon brush, and the brush sleeve being fixable on the housing of the electric machine in the use position of the brush sleeve; and
a catcher to lock the brush sleeve in the safety position when the brush sleeve leaves the use position.

15. The brush arrangement of claim 14, wherein the electric machine is an electric domestic appliance.

16. The brush arrangement of claim 14, wherein the catcher includes at least one locking facility that catches the brush sleeve in the safety position in a locked fashion.

17. The brush arrangement of claim 16, wherein the brush sleeve has a radial surface; and wherein the locking facility includes a recess provided on the radial surface of the brush sleeve in which a lug resting against the radial surface in the use position engages upon reaching the safety position.

18. The brush arrangement of claim 17, wherein the recess is embodied in one of a circular and rectangular form.

19. The brush arrangement of claim 18, wherein the rectangular form is a square form.

20. The brush arrangement of claim 14, wherein the brush sleeve is electrically conductive.

21. The brush arrangement of claim 20, wherein the electric machine has a stator including a contact spring; and wherein the lug is formed by the contact spring of the stator.

22. The brush arrangement of claim 17, wherein the electric machine has a commutator and a stator, and wherein the recess is arranged in the use position in a radial direction between the commutator and the stator of the electric machine.

23. The brush arrangement of claim 22, wherein, in the use position of the brush sleeve, a contact spring of the stator rests at an incline against the radial surface of the brush sleeve in direction of the commutator.

24. The brush arrangement of claim 14, wherein the housing of the electric machine is electrically conductive.

25. The brush arrangement of claim 24, wherein the brush sleeve is fastened to an electrically insulating load-bearing portion insertable into retaining means provided on the housing.

26. The brush arrangement of claim 25, wherein the electrically insulating load-bearing portion is pushed into the retaining means.

27. The brush arrangement of claim 25, wherein the electric machine has a commutator, and wherein the electrically-insulating load-bearing portion is inserted into the retaining means of the housing in direction of the commutator.

28. The brush arrangement of claim 14, wherein the catcher includes a projection on the brush sleeve, which, in the safety position, strikes a safety element.

29. The brush arrangement of claim 28, wherein the electric machine has a stator including a contact spring, and wherein the safety element is the contact spring.

30. An electric machine, comprising:
a housing;
a carbon brush;
a brush sleeve having a use position and a safety position, the brush sleeve holding the carbon brush, and the brush sleeve being fixable on the housing of the electric machine in the use position of the brush sleeve; and
a catcher to lock the brush sleeve in the safety position when the brush sleeve leaves the use position.

31. The electric machine of claim 26, wherein the electric machine is an electric domestic appliance.
